(19) United States
(12) Patent Application Publication
(10) Pub. No.: US 2005/0021356 A1
(43) Pub. Date: Jan. 27, 2005

(54) Retail furniture store configuration and method

(75) Inventor: David Thompson, Columbus, OH (US)

Correspondence Address: WOOD, HERRON & EVANS, LLP, 2700 CAREW TOWER, 441 VINE STREET, CINCINNATI, OH, 45202, US

(73) Assignee: Schottenstein Stores Corporation

(21) Appl. No.: 10/772,775

(22) Filed: Feb. 5, 2004

Related U.S. Application Data
(60) Provisional application No. 60/445,152, filed on Feb. 5, 2003.

(51) Int. Cl. G06F 17/60

(52) U.S. Cl. 705/1; 705/10

(57) ABSTRACT

A furniture and related product marketing concept includes providing a furniture store with an arrangement in which aisles end in terminal furniture groupings selected and arranged so as to attract customers of different lifestyles to respectively different areas of the display area of the store. At these areas, one or more sections of the display floor space are each configured as a pod in which a plurality of furniture groupings arranged as a plurality of rooms of a single house or residence is decorated with products to appeal to persons of the lifestyle attracted by the terminal furniture groupings. The products may include furniture, decorating materials and services for providing wall, floor and window coverings, accessories and other household lifestyle products compatible with the styles of the pod furnishings and likely to be of interest to customers of the respective lifestyles.

### RELATED APPLICATIONS

This application claims priority from and is related to U.S. Provisional Patent Application Ser. No. 60/445,152, entitled RETAIL FURNITURE STORE CONFIGURATION AND METHOD, which is incorporated herein by reference in its entirety.

### TECHNICAL FIELD

The present invention relates to the marketing of furniture and other consumer retail products, and more particularly, to the organization and operation of product display and other areas of a retail furniture store.

### BACKGROUND OF THE INVENTION

In traditional furniture showrooms, furniture products are typically grouped by category, that is, sofas are grouped together in one part of a store, dining room tables are grouped together in another area of the store, bedding in still another. Sometimes furniture is presented in groupings, for example with a sofa, matching chair, coffee table and ottoman assembled in an arrangement, or with bed, dresser and nightstand grouped together, or with a dining room table, chairs and credenzas together, etc. Occasionally, room arrangements are displayed, some with art or other objects added for decoration.

Furniture store customers, however, live in residences in which the rooms are filled with a variety of objects, not just furniture or items assembled by a decorator. Other products that furnish a customer's rooms are typically marketed in different and dispersed departments of a department store or in different stores that specialize in such products. Electronics stores display and sell televisions and entertainment centers, and recorded programs and communications services may be sold in record stores or communications centers. Dishes and tableware, lighting and electric appliances, art work, carpeting, wall finishes, window coverings, and other items that occupy the rooms of a person's home are usually available in stores or departments of stores specializing in such products.

A consumer shopping for products in any of such classes must go through the exercise of selecting from among a wide variety of products in each class the particular products that suit that consumer's subjective needs and tastes. It is the consumer who must initiate the shopping activity after making a conscious decision on the need or desire for a particular type of goods. Unless a customer searches out and visits a particular store or department of a store, the customer may do without a particular class of product. Alternatively, separate marketing efforts must be made by the retailers of the various types of products to cause the consumer to shop for those particular products. Consumers are increasingly faced with less time to shop.

The effort required by the merchant and the time and initiative required by a consumer are obstacles to the marketing of products and add to marketing costs. With consumer's time being increasingly more limited, such obstacles reduce the sales of products that consumers would otherwise be willing to buy, and make the task of furnishing a home or buying other products more time consuming and costly, and less satisfying for the consumer.

Accordingly, an improved system for marketing home furnishings is needed.

The marketers of furniture and related products have long had the capabilities of determining the tastes of customers based on their attraction to certain products or based on a knowledge of demographic characteristics of the customer. Such determinations have been capable of use in targeting customers with promotions of other products that marketing data or merely marketer experience shows are likely to be of interest to customers classified on the basis of their interests in products in totally different categories. With on-premises shopping face-to-face retailing, the promotional methodology in targeting customers is often not rigorously documented. With internet based systems, however, the use of rigorous marketing theories and their reduction to algorithms is essential. With on-premises retail sales, the use of targeted marketing of varied products is far less easily implemented.

Accordingly, there is a need for adapting targeted marketing techniques to on-site retail displays, particularly for marketing home furnishings, accessory and other products.

### SUMMARY OF THE INVENTION

The present invention relates to a method for providing a more effective way of displaying furniture in a retail furniture store. One aspect of the present invention relates to providing a retail display for marketing furniture as well as accessories and other products to consumers, and to match consumers with the particular products that they are likely to prefer. A particular aspect relates to providing a store and method for marketing furniture and associated accessories and decorating products for different parts of an entire residence in a manner that identifies and targets different types of consumers.

According to the principles of the present invention, furniture as well as accessories and other non-furniture products and services are marketed to retail customers by assembling the products on the basis of a particular lifestyle with which the consumer identifies. The invention uses a retail furniture store display system that is designed to attract the customer to a portion of a display by presenting the customer with items characteristic of a variety of lifestyles from which the customer may choose. The store is configured so that a selection of a lifestyle by a customer results in a positioning of the customer in a portion of a showroom that places the customer among products likely to be of interest to consumers who identify with that selected lifestyle. So positioned, the customer is introduced to furniture products and accessories and other non-furniture goods and services of all levels that are likely to be attractive to such customer. The lifestyle identity of the customer is used to market not only furniture but other products likely to be preferred by that customer.

According to illustrated embodiments of the present invention, a retail furniture store enclosure or sales facility is provided with a display area divided into a plurality of pods. Each of the pods is a portion of the display area that contains home furnishings and decorative accessories available for sale. The home furnishings and decorative accessories contained in each of the different pods are identifiable, respectively, with different ones of a plurality of different lifestyles. The home furnishings and decorative accessories of each respective pod may include furnishings and accessories such as furniture, wall coverings, floorcoverings, blinds, window coverings, electronics, lighting fixtures, sculpture, mirrors and pictures that are mutually compatible in design and identifiable with the respective lifestyles associated with the respective pod. Outdoor products compatible with the same lifestyle may also be included, such as, lawn furniture, garden tools, grills, hoses, saddles, bike racks, sporting goods, etc. The store enclosure may also include one or more checkout locations. An array of intersecting aisles within the display area provides pedestrian access to, from and among each of the pods and the checkout locations.

The array of aisles in illustrated embodiments of the invention preferably includes aisles terminating in groupings of furniture compatible with the lifestyles of pods adjacent thereto. Such groupings, so placed, attract the customer toward a grouping of choice, and down an aisle that leads to a location in the store adjacent pods most compatible with a lifestyle suggested by the style of the selected grouping. The lifestyles may be characterized by furniture styles or collections. Preferably, these collections will be newly created or evolving styles, but the differences among such styles might be better understood by reference to the characteristics of more traditional and documented styles. Terms such as Victorian, Jacobean, Tudor, Venetian, Louis XV, French Provincial, Georgian, and Baroque all suggest certain looks that can be associated with the tastes of different demographic groups of people. Textiles, texture, woods and finishes also can serve as one of several elements in classifying furniture according to lifestyle preferences. Country or regional identification of furniture styles may also be useful in such classifications, for example, French, English, Chinese, Japanese, Dutch, Italian, American (e.g., early, Shaker, Pennsylvania Dutch, etc.).

For example, a living room grouping of a functional Scandinavian style furniture collection might be placed at the end of an aisle near the perimeter of a display area so that it is visible by a customer in the aisle. Such a grouping might, as determined by marketing research or experience, attract a relative young moderate income working person or professional down the aisle toward the grouping. Adjacent to the grouping or to the aisle terminating in the grouping may be a plurality of pods decorated with furniture groupings of the same or other collections that are determined to have likely appeal to customers attracted to the grouping. These pods would contain various furnishings of different parts of an entire residence of compatible furnishings, including furniture and accessories. Among these accessories may be, for example, electronics and components of an entertainment center, which marketing information leads one to expect such customers to desire. The furnishings within these pods would be united by paint and other wall coverings, carpets and other floor coverings, bedspreads, accent lighting, and/or window trim and coverings that are determined to be consistent with the tastes of customers of the same given lifestyle, and the materials and services for which are made available for sale to the customer attracted to such pods. Electronics components and entertainment centers might be featured in the pods as appealing to the attracted customers.

As another example, the opposite end of the same aisle or the end of another aisle might contain bedroom furniture of an early American or colonial style might that attract an older, more conservative customer than in the example above. Dark wood furniture, subdued wall coverings with wall-to-wall carpeting or area rugs coordinated with and accenting the wall tones would tie the grouping together. Adjacent this grouping would be pods decorated to include living room, dining room and bedroom alternative arrangements of furniture, accompanied by traditional accessory lamps, artwork and display items, and tied together with compatible wall, window and floor coverings and trimmings. Customers attracted by the lifestyle associated with such decor might be more likely to furnish a home with purchases of lamps, candles or figurines.

Lifestyles are defined on the basis of determinations that furnishings of certain designs appeal to certain people of one such lifestyle while furnishings of other designs appeal to people of another such lifestyle. People of the different lifestyles have corresponding likelihoods of having particular leisure time activities, particular interests and particular preferences for certain accessories. The contents of the products within the pods that are appropriate for each given lifestyle may be determined in a number of ways, from the application of the most scientific marketing research and analysis to the use of human decision making that might not be articulated in language or reduced to a formula or algorithms. In the latter case, such decisions should be made by persons whose education and experience in furniture design, decorating, merchandising or human psychology or behavior qualify them and render then likely to make such decisions. However, the rapid current development of sophisticated marketing research and customer data correlation techniques, for example as are being or will be used by internet marketers, supermarket and retail chains, etc., are replacing the more subjective human decision making with more objective automated or computer assisted decision making based on actual marketing data.

In the display area, the plurality of pods are visually and physically separated from each other either by the aisles or by other elements that cause the customer to focus on a limited section of the space which constitutes the pod. Such elements may include, in addition to the aisles, lighting, floor finish, floor color, floor covering, floor elevation, signage and walls or partitions, large furniture items or arrangements, space dividers and other such elements. The pods, so separated, are visually and physically distinguishable areas of the display floor space that can be each decorated in accordance with a given lifestyle. Typically, such decoration is in the form of a portion of a room or as one or more finished rooms.

Each lifestyle is representative of a given segment of consumers that have common tastes, customs or preferences, which may be determined by marketing, psychological or other data. Each of the pods is decorated with products that are identifiable with the given lifestyle and that the particular groups of consumers associated with that lifestyle are likely to prefer and purchase. The products include furniture and other room furnishings and decorations that may include wall coverings, window coverings, floor coverings, paint colors, and may also include electronics or accessories that are likely to be placed together by designers or assembled by consumers of the group associated with the given lifestyle of the pod. The products can also include information on or links to services, or to leisure time activities, likely to be desired by consumers of the given lifestyle, such as communication services, travel services, sports and entertainment, grooming or health related products and services, or any of a wide variety of items likely to be of interest to persons of a given lifestyle.

In accordance with certain specific embodiments of the invention, a store enclosure may be provided in which a display area is laid out and divided into the plurality of pods described above, with each of the pods, for example, decorated in a compatible design as a finished room or as a “whole house” layout of different rooms, each with products for sale and identifiable with one of a plurality of different lifestyles. The products decorating each respective pod include furniture and other goods or services of a compatible design and related to the same lifestyle. Elements of compatible design may be related by color and design style, and include paint or other wall finish, floor covering, window covering, and the sources of these products, which may be companies partnered with the furniture sales facility. Electronics such as entertainment systems, security systems, communications systems, computer systems or various automation accessories may be matched to various of the lifestyles. Accessories such as games, toys, tools, appliances, dishes and utensils, cookware, publications and recordings may be included. Sports, recreational or athletic equipment may also be included. Companies providing services may be identified and the services may be sold by way of displays in the pods. Such services may include travel services, maintenance services, that are mutually compatible with consumers identified with the particular lifestyle.

In certain embodiments of the invention, an array of intersecting aisles is provided within the display area which provides pedestrian access to, from and among each of the pods, a central office, a checkout location, a design center and other functional areas of the store. Certain of the aisles may terminate in groupings of furniture or common areas decorated in a manner compatible with more than one lifestyle, each of which may be the theme of a pod adjacent thereto.

An entry space communicating between the outside of the enclosure and the array of aisles of the display area introduces the customer to the display. The entry space may be designed to introduce and psychologically adjust an entering shopper with the company that operates the facility as well as educate the customer on the the general nature of the products being sold. This entry space may included, for example, an entry room or chamber through which entering consumers walk that is provided with museum-like displays diagrammatically depicting furniture manufacturing or company history, or introducing company personnel.

For example, an entry hall or chamber may be provided immediately inside of the main customer entry of the store. The chamber communicates with and provides pedestrian passage between the outside of the enclosure and the array of aisles of the display area. The entry hall is preferably decorated and furnished in such a way as to psychologically acclimate an entering customer to the shopping experience inside of the store. In certain embodiments of the invention, the entry hall is furnished in a museum style, with informational displays. Such displays may include, for example, a display diagrammatically depicting the process of manufacturing furniture, explaining material acquisition such as selecting prime woods, fabricating metal, or processing textiles, through the assembly and finishing of furniture products. Such displays may also or alternatively include, for example, an informational display depicting the facts relating to the founding and history of the store or the retail entity associated with the store. The entry may also include seasonal merchandise like Christmas and also like spring lawn and garden.

Each of the pods of the plurality of pods is preferably visually and physically separated from the others, preferably but not necessarily, by these aisles. The extent of each pod is made apparent by the presence and arrangement of unifying elements such as lighting, carpeting, color or floor finish. The pods may be set out by elevated platforms or dividing structures. Signage may also be used to identify or distinguish the different pods.

A design center, when provided within the store, contains work areas for customers to meet with designers. The array of intersecting aisles also provides pedestrian access to, from and among each of the pods and the design center.

An office area may also be provided within the store enclosure. The array of intersecting aisles may then also provide pedestrian access to, from and among each of the pods and the office area.

These and other objectives and advantages of the invention will be more readily apparent from the following detailed description of the drawings.

### BRIEF DESCRIPTION OF THE DRAWINGS

FIG. 1 is floor plan of one embodiment of a retail furniture store according to principles of the present invention.

FIG. 2 is a more detailed diagram of a portion of FIG. 1 showing furniture arrangement.

### DETAILED DESCRIPTION OF THE DRAWINGS

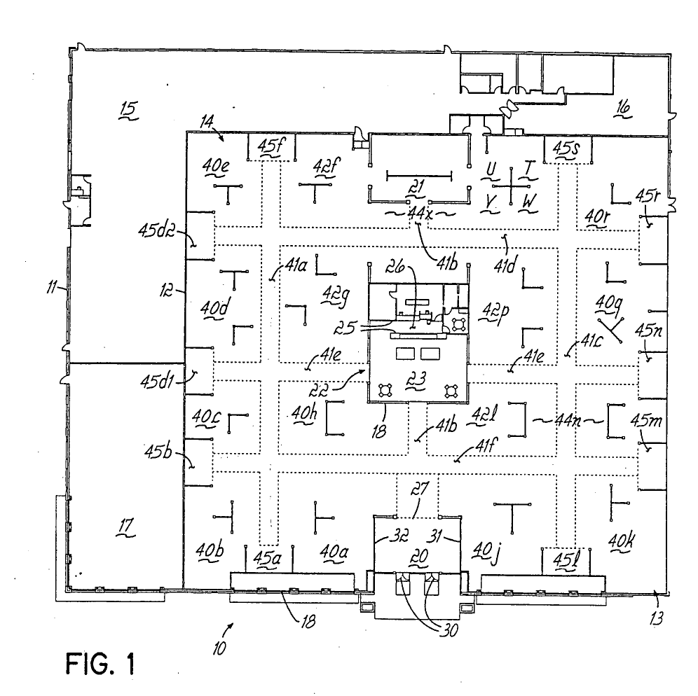

FIG. 1 illustrates the floor plan of a retail furniture store 10 embodying principles of the present invention. The store 10 is contained in a building having an exterior wall 11 and an inner wall 12, which define an enclosure in which is contained a retail furniture display area or furniture gallery 14. The inner wall 12 is shown as generally L-shaped and separates areas that are not accessible to customers from the display area 14, including warehouse space 15 for supplying the retail furniture facility, an employee area 16 and another store front retail space 17, which may be of a related or unrelated business. Such space 17 could, for example, include a paint, wall covering, window covering or carpeting store that supplies those decorating materials displayed and sold in the display area or gallery 14.

The display area 14 is generally rectangular and is bounded by the inner wall 12 on one side and the back and by the outer wall 11 on the front and its other side. Storefront windows 18 are included in the outer wall 11 at the front of the display area 14. Within the rectangular space between the inner and outer walls 11 and 12 that define the display area 14 are three generally rectangular areas partitioned from and carved out of the display area 14. These areas include an entry gallery 20 at the center of the front of the display area 14 along the front outside wall 11, a bedding gallery 21 at the center of the back of the display area 14 along the back interior wall 12, and a design and office area 22 in the middle of the display area 12. In this area is provided internet access for consumers to see additional products not shown on display in the store.

The design and office area 22 includes, at its front, a design center 23 that is separated from the display area 14 by low partitions 24, and, at its back side, offices 26 separated from the design center 23 and display area 14 by full height partitions 25. This area is a centrally located area within the display area 14 at which design services and advice are provided to customers by employees or consultants associated with the store 10.

The entry gallery 20 communicates with the outside 30 of the store 10 through main doors 28 for the entry and egress of customers. The entry gallery 20 also communicates with the display area 14 of the store 10 through an open doorway 27. The entry gallery 20 is furnished as a museum-like space with informational displays that will psychologically acclimate the entering customers to the retail furniture sales of the facility. The informational displays include, for example, a first informational display 31 on one side of the entry gallery 20 that depicts the furniture manufacturing process, from the global acquisition of the materials of which the furniture is made, e.g., woods, textiles and other materials, through design, fabrication, assembly and finishing of the furniture products. The displays may also include, for example, a second informational display 32 on the opposite side of the entry gallery 20 from the first display 31 depicting the facts relating to the company operating the store 10, including, for example, a history of the company's origin, its designers and other key employees, and the services it provides.

The display area or furniture gallery 14 is divided into a plurality of pods 40. Each of the pods 40 is decorated as a finished room, with floor and wall coverings, furniture and lighting, along with accessories and details such as window coverings, paint and wall paper, electronics, art work and crafts, and all such other items that might be present in a finished room in a home that is inhabited by people like the customers. Each of the pods is decorated in accordance with a given lifestyle. Each lifestyle has associated with it design tastes, personal activities, hobbies and conveniences of a particular group of people. Different pods 40 are decorated in accordance with different lifestyles. The pods 40 in the figures are designated 40a, 40b, . . . , to indicate the different lifestyles a, b, . . . , for which they are decorated. All of the items within the pod 40, from furniture to fabrics to paint to electronics equipment, to items on the shelves, etc., are compatible with each other and are selected by experts to be suitable as part of a single decorating scheme. The range of products within a pod 40 includes items that are likely to be preferred by the same customer whose preferences can be associated with a given lifestyle, as determined by marketing experts from marketing data.

Each pod 40 is visually and physically separated from the pods corresponding to other lifestyles by various structures and effects, particularly by pedestrian aisles 41. For example, an orthogonal grid of straight longitudinal (front to back) and transverse (side to side) aisles divides the display area 14 into an array of cells. In FIG. 1, three transverse aisles 41a, 41b and 41c and three longitudinal aisles 41d, 41e and 41f divide the display area 14 into sixteen cells that are potential areas in which a pod 40 may be constructed. Such pods 40 are divided by aisles 41 from other such pods. The number and layout of the aisles may be different if the store floor space or shape is different. In the embodiment shown in FIG. 1, ten full cell pods 40 are depicted, namely pods 40a, 40b, 40c, 40d, 40e, 40h, 40j, 40k, 40q and 40r. Each of these pods 40 is decorated in accordance with one of ten lifestyles, namely, a, b, c, d, e, h, j, k, q and r, respectively. Within each of these pods 40, the areas are visually grouped together by use of various decorating or structural elements such as, for example, common paint, carpeting, lighting as well as the lifestyle characteristics, and also optionally by use of more distinct structural features such as raised platforms or partitions.

Other pods may include pods 42 made up of only part of a cell that are divided from other pods occupying part of the same cell by partitions or other structures or decorating schemes. Such pods 42 include pods 42f, 42g, 42l and 42p, which include the major portions of individual cells and are decorated in accordance with lifestyles f, g, l and p, and may include other smaller pods 43 that occupy only a minor portion of a single cell, such as pods 43m, 43t, 43u and 43w, decorated in accordance with lifestyles m, t, u and w, respectively. Other pods 44 may, where their decorating schemes so allow, be arranged across an aisle and occupy portions of more than one adjacent cell, such as pods 44n and 44x, decorated in accordance with lifestyles n and x, respectively.

In addition to the pods 40, 42, 43 and 44, furniture and product groupings 45 are provided, preferably located at the ends of aisles or in other places that are likely to be viewed by a customer navigating the aisles. So positioned, the groupings catch the eye of the customer and, if possessed of a style that is of interest to that customer, will influence the customer in selecting a direction of travel along the aisles 41, bring that customer to a location in the display area 14 that is adjacent lifestyles that are likely to be of further interest to that customer. Such groupings include groupings 45a, 45b, 45d1, 45d2, 45f, 45l, 45m, 45n, 45r and 45s, which are decorated with lifestyles a, b, d1, d2, f, l, m, n, r and s, respectively. Such groupings match a lifestyle with which a pod immediately adjacent the grouping is decorated and also is compatible with the lifestyle with which other proximate or adjacent pods are decorated. The compatible lifestyles of these proximate pods are lifestyles that have certain common appeal of persons identifying with or preferring the lifestyle or has some design compatibility such that products of the proximate lifestyles can be used together. Such groupings might include a living room seating area, a bedroom sleeping area or some other grouping of furniture, decor or art that is particularly characteristic and eye-catching.

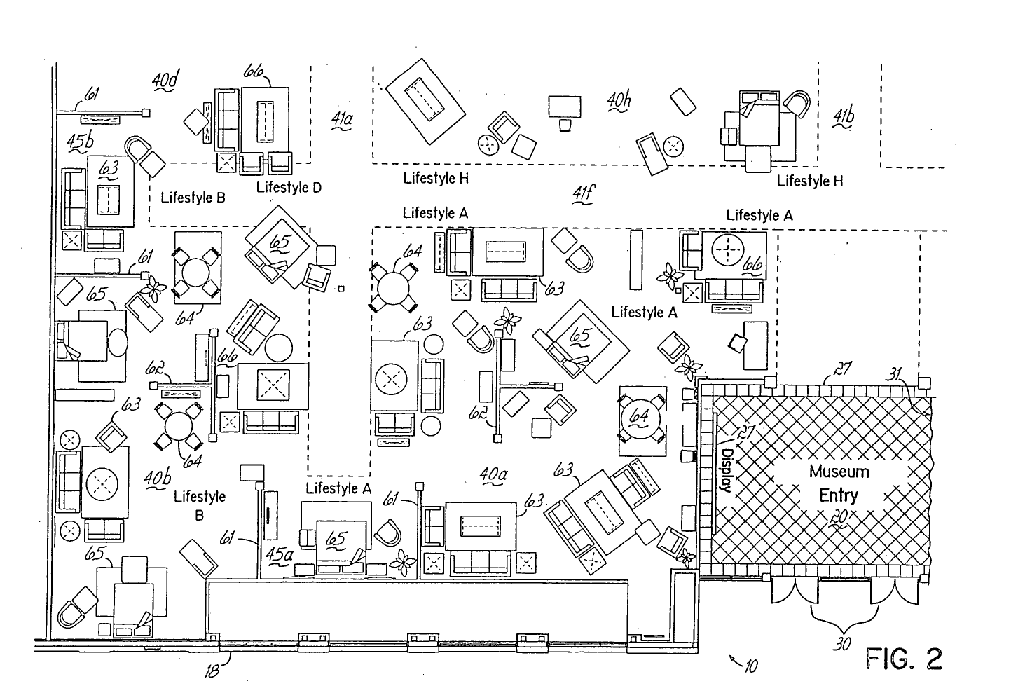

Each of the various lifestyles referred to herein and in FIGS. 1 and 2 includes a furniture collection selected as having a design particularly appropriate for that lifestyle. The lifestyles identified above by the letter following the numbers of the full-cell pods 40, the partial cell pods 42, the multiple cell pods 44 and the groupings 45 relate. A skilled artisan in this field would recognize that furniture collections are differentiated by design styles, wood color, relative scale, trim and molding features, door styles, drawer shapes, hardware and hinges, and a variety of other characteristics. Typical categories include Colonial, European, Art-Deco, Greek Revival, Eclectic, Contemporary, Antique, etc. and within each such category are recognized sub-categories. Examples of some different furniture collections are marketed by the Assignee of the present application under its trademarks as identified in all-capital letter names in the first column of Table 1 below. Illustrations of examples of certain of the styles are depicted in the drawings of U.S. design patent applications identified in Table 1 and, therefore, not reproduced here as each of these applications is hereby expressly incorporated herein by reference in its entirety.

TABLE 1

| Life- | | Related |
|---|---|---|
| style | Furniture Style | Applications |
| a | A tropical colonial style, African, Asian and | 29/163,514 |
| | Carribean style of furniture collection, an | 29/161,780 |
| | example of which is marketed as the | 29/161,741 |
| | AMERICAN SIGNATURE WEST INDIES | 29/161,891 |
| | COLLECTION | 29/161,833 |
| | | 29/162,335 |
| | | 29/163,515 |
| b | An eclectic or fusion of traditional and | 29/165,109 |
| | contemporary styles of furniture collection, an | 29/164,153 |
| | example of which is marketed as TODAY'S | |
| | TRADITIONS COLLECTION | |
| c | A traditional regal style of furniture collection, | |
| | an example of which is marketed as the | |
| | GRAND REGENCY COLLECTION | |
| d | A Mediterranean, California and Provincial | |
| | country style collection, an example of which | |
| | is marketed as the VINEYARD MANOR | |
| | COLLECTION | |
| e | An antique style country European or early | |
| | American colonial collection, an example of | |
| | which is marketed as the 18th CENTURY | |
| | COLLECTION | |
| f | A simple Greek revival, federalist or | |
| | American 19th Century country style | |
| | collection, an example of which is marketed | |
| | as the TOWN HALL COLLECTION | |
| g | A simple urban style collection, an example | |
| | of which is marketed as the EAST VILLAGE | |
| | collection. | |
| h | An ornamental American/Victorian style | D463,155 |
| | collection, an example of which is marketed | 29/159,499 |
| | as the AMERICAN SIGNATURE HEIRLOOM | 29/159,488 |
| | PINE COLLECTION | D463,157 |
| | | 29/164,013 |
| i | n/a | |
| j | A modern high-tech style collection, an | D462,540 |
| | example of which is marketed as the | 29/159,629 |
| | AMERICAN SIGNATURE STUDIO ONE | 29/161,873 |
| | COLLECTION | 29/162,077 |
| k | A collection of leather furniture pieces, an | |
| | example of which is marketed as the | |
| | AMERICAN SIGNATURE LEATHER | |
| | collection | |
| l | A rustic collection of contemporary hand | D459,907 |
| | made style furniture in natural wood finishes, | 29/159,498 |
| | an example of which is marketed as the | 29/162,093 |
| | AMERICAN SIGNATURE ARTS & CRAFTS | |
| | COLLECTION-natural or light pieces | |
| m | An early 20th century style furniture | |
| | collection, an example of which is marketed | |
| | as the WEST PALM COLLECTION | |
| n | A rustic collection of contemporary hand | see I |
| | made style furniture in dark wood finishes, an | |
| | example of which is marketed as the | |
| | AMERICAN SIGNATURE ARTS & CRAFTS | |
| | COLLECTION - chocolate or dark pieces | |
| o | n/a | |
| p | A country vacation style collection, an | |
| | example of which is marketed as the LAKE | |
| | COTTAGE collection. | |
| q | An early American style furniture collection in | |
| | natural wood finishes in a country decor, an | |
| | example of which is marketed as the | |
| | AMERICAN SIGNATURE NATURAL PINE or | |
| | NATURAL PINE collection. | |
| r | An early American style furniture collection in | D462,193 |
| | natural wood finishes in a nautical or New | 29/149,593 |
| | England coastal decor, an example of which | |
| | is marketed as the SEA ISLAND | |
| | COLLECTION and the AMERICAN | |
| | SIGNATURE SEA ISLAND collection | |
| s | A floral trimmed style, an example of which is | |
| | marketed as the FOREVER ROSES | |
| | collection. | |
| t | A veranda, porch, sun room or garden style, | D462,848 |
| | examples of which are marketed as the | 29/159,497 |
| | AMERICAN SIGNATURE ROSE GARDEN | 29/159,478 |
| | COLLECTION and the ROSEMARY'S | 29/161,763 |
| | GARDEN COLLECTION | |
| u | Youth furniture of the style n and t referred to | see n and t |
| | above | |
| v | Youth furniture of the style/referred to above | see l |
| w | A ribbed wood style, an example of which is | |
| | marketed as the BEADBOARD collection | |
| x | Art Deco and other early 20th century styles, | |
| | an example of which is marketed as the | |
| | RETRO collection. | |

FIG. 2 diagrammatically illustrates an enlarged layout of a portion of FIG. 1 that includes pod 40b, portions of pods 40a, 40c and 40h, and groupings 45a and 45b. Grouping 45a terminates the aisle 41a with a grouping of bedroom furniture in a design of the lifestyle “a”. It includes a king-size poster bed, nightstands, a chair and a dresser. Grouping 45b terminates the aisle 41f with a grouping of living room furniture including a table and accompanying chairs and couch. In each area 45a and 45b, a rug, wall covering, window covering, lighting and other accessories are selected to be compatible with the design and to visually group the furnishings in the area 45a and 45b. Partitions 61 along with the aisles 41a and 41f separate the grouping 45a and 45b from the adjacent pods 40a, 40b and 40c. The furnishings within the groupings 45 relates to a particular room, which, in the case of grouping 45a, is a bedroom, that is, a sleeping area 65, and in the case of grouping 45b, is a living room or living area 63.

The furnishings within the pods 40 include groupings of furnishings for a whole house, including living, eating, sleeping and recreation areas 63-66, respectively, as illustrated for pods 40a and 40b in FIG. 2. As shown, these furnishings include accessories, tables, chairs, couches, stools, beds and bureaus. In accordance with the principles of the present invention the pods 40 are furnished with items that have been identified as compatible with the style of furniture of the nearest furniture grouping 45 and that have been identified as attractive to the consumer demographic interested in that style of furniture. Thus, alternatively furnished groupings may be displayed in each of the pods 40 and partitions 62 may be deployed to break up the space within the pods 40 to separate the alternative groupings.

A number of different furniture styles associated with a corresponding lifestyle have been identified in, such as in table 1, to assist with describing the present invention. These exemplary lifestyles and furniture styles are not intended, however, to limit the scope of the present invention. Marketing experts and designers recognize that a design lifestyle incorporates a wide variety of different elements such as, for example, the type of wood (e.g., pine, cherry, etc.), the type of finish (e.g., natural, inlaid, etc.), the type of material (e.g., chrome, wood, etc.); the scale (e.g., large, delicate, etc.), the fabrics (e.g., patterned, solid, etc.), color schemes (e.g., bright, subdued, etc.), floor coverings (e.g., area rugs, carpeting, etc.), accessories (e.g., electronics, outdoor items, etc.), and window treatments (e.g., drapes, blinds, etc.). Thus, embodiments of the present invention are not limited to the specific exemplary furniture styles or the exemplary lifestyles identified in Table 1; but, instead, contemplate organizing furniture and accessory items for sale according to any compatible lifestyle design that is recognizable through marketing and consumer research.

For example, a bedroom or living room furniture arrangement may be configured with a Scandinavian or similar style furniture. This style of furniture may be recognized as attractive to younger people who are unmarried. Additional consumer research might indicate that this demographic likes lighter colored fabrics that have colorful patterns. This demographic may also prefer track-lighting over lamps and enjoy music by contemporary artists on the newest electronic equipment. A different furniture style arrangement, such as American Colonial, however, may be used to attract a consumer with a different lifestyle. Consumers within this other lifestyle may be older and wealthy. Marketing research may have uncovered that they enjoy darker, richer tones with subdued coloring when purchasing floor coverings and window treatments. This demographic may also enjoy traditional entertainment, have a lot of leisure time and purchase electronic or outdoor equipment by high-end manufacturers.

Accordingly, for each such furniture style, the surrounding pod (or pods) will be designed in a design style compatible with the lifestyle of the intended demographic and be furnished with accessories that the intended demographic would want to purchase. In this manner, the consumer is drawn to a particular region of the store based on the furniture style compatible with their lifestyle and then, once within this region, is presented with other items for sale that have been selected based on that lifestyle. Thus, the consumer is able to shop for not only attractive furniture but other compatible accessories for their lifestyle in one general location.

The store 10 of FIG. 1 may not always include enough pods to correspond to all the available types of furniture styles that are available to be marketed. Thus, the different furniture styles may be rotated through the store 10. Also, as new furniture styles are developed, a new style may be used to replace an existing style in one of the arrangements 45 and/or pods 40. When a new or different furniture style is introduced into the store 10 any of a number of recognized methods may be utilized to identify the accessories and other design characteristics that are attractive to the consumer segment that likes that particular furniture style. Once tastes of the intended demographic are identified, then the nearby pod (or pods) may be designed and furnished with appropriate items. Thus, in their broadest sense embodiments of the present invention are not limited to only specific furniture styles or particular consumer lifestyle types. Instead, in accordance with the principles of the present invention, the marketing of furniture and other non-furniture accessories and furnishings is accomplished with respect to any style of furniture for which an accompanying demographic lifestyle is identified along with the respective tastes and products associated with that lifestyle.

1. A store for displaying home furnishings and decorative accessories for sale comprising:
a store enclosure;
a display area within the store enclosure which includes a plurality of pods, each of the pods containing home furnishings and decorative accessories available for sale, the home furnishings and decorative accessories of the different pods being identifiable, respectively, with different ones of a plurality of different lifestyles, the home furnishings and decorative accessories of each respective pod including home furnishings and decorative accessories selected from the group consisting essentially of furniture, wall coverings, floor coverings, window coverings, electronics, lighting fixtures, sculpture, mirrors and pictures that are mutually compatible in design and identifiable with the respective one of the different lifestyles;
a checkout location within the store enclosure;
an array of intersecting aisles within the display area and providing pedestrian access to, from and among each of the pods and the checkout location, the array including aisles terminating in groupings of furniture compatible with the lifestyles of pods adjacent thereto;
an entry space communicating and providing pedestrian passage between the outside of the enclosure and the array of aisles of the display area; and
the plurality of pods being visually and physically separated from each other by components selected from the group consisting essentially of aisles, lighting, floor finish, floor color, floor covering, floor elevation, signage and walls.

2. The store of claim 1 wherein:
the entry space includes a first informational display diagrammatically depicting a process of manufacturing furniture from material acquisition through the finishing of furniture products and a second informational display depicting the facts relating to a retail entity associated with the store.

3. The store of claim 1 further comprising:
a design center location within the store enclosure;
the array of intersecting aisles providing pedestrian access to, from and among each of the pods and the design center location.

4. The store of claim 1 further comprising:
an office area within the store enclosure;
the array of intersecting aisles providing pedestrian access to, from and among each of the pods and the office area.

5. The store of claim 1 further comprising:
a design center location within the store enclosure; and
an office area within the store enclosure;
the array of intersecting aisles providing pedestrian access to, from and among each of the pods, the design center location and the office area.

6. The store of claim 1 wherein:
at least one of the pods includes wall partitions internal to the pods dividing the pods physically and visually into a plurality of rooms.

7. A store for displaying furniture and other products for retail sale comprising:
a store enclosure;
a display area within the store enclosure which includes a plurality of pods, each of the pods containing home furnishings and decorative accessories available for sale, and each pod so designed being identifiable with a different one of a plurality of different lifestyles, the home furnishings and decorative accessories of each respective pod including furniture and home furnishings and decorative accessories selected from the group consisting essentially of wall coverings, floor coverings, window coverings, electronics, lighting fixtures, sculpture, mirrors and pictures that are mutually compatible in design and identifiable with the respective one of the different lifestyles;
an array of intersecting aisles within the display area and providing pedestrian access to, from and among each of the pods; and
the plurality of pods being visually and physically separated from each other by features including the aisles and grouped by unifying elements selected from the group consisting essentially of lighting, rugs or floor finish, elevated structures and signage.

8. The store of claim 7 further comprising:
a central office checkout location within the store enclosure;
the array of intersecting aisles providing pedestrian access to, from and among each of the pods and the central office checkout location.

9. The store of claim 7 further comprising:
groupings of furniture compatible with the lifestyles of pods adjacent thereto;
the array including aisles terminating in the groupings.

10. The store of claim 9 wherein:
at least some of the groupings of furniture are visible for the length of the aisle that terminates in the respective grouping such that characteristics of a lifestyle can be perceived by a customer throughout the length of the aisle.

11. The store of claim 7 further comprising:
an entry space communicating and providing pedestrian passage between the outside of the enclosure and the array of aisles of the display area, the entry space including one or more informational displays relating to the store or business of the store or the manufacture of products sold therein.

12. The store of claim 7 further comprising:
an entry space communicating and providing pedestrian passage between the outside of the enclosure and the array of aisles of the display area, the entry space including a first informational display diagrammatically depicting a process of manufacturing furniture from material acquisition through the finishing of furniture products and a second informational display depicting the facts relating to a retail entity associated with the store.

13. The store of claim 7 further comprising:
a design center location within the store enclosure;
the array of intersecting aisles providing pedestrian access to, from and among each of the pods and the design center location.

14. The store of claim 7 further comprising:
an office area within the store enclosure;
the array of intersecting aisles providing pedestrian access to, from and among each of the pods and the office area.

15. The store of claim 7 further comprising:
a design center location within the store enclosure; and
an office area within the store enclosure;
the array of intersecting aisles providing pedestrian access to, from and among each of the pods, the design center location and the office area.

16. The store of claim 7 wherein:
at least one of the pods includes wall partitions internal to the pods dividing the pods physically and visually into a plurality of rooms.

17. A method of displaying furniture and accessories for retail sale comprising:
arranging a retail furniture display with furniture groupings decorated and positioned to identify customers of different lifestyles by attracting those customers on the basis of the corresponding lifestyle to different areas of a store; and
arranging furniture accessories and other non-furniture products in the store for display by locating products among the different areas in accordance with the marketability of such products to the customers so attracted to the respective areas.

18. The method of claim 17 further comprising:
so attracting the customers by decorating and furnishing said area of the store such that it is visible from a location remote from said area.

19. The method of claim 17 further comprising:
so attracting the customers by decorating and furnishing said area of the store such that it is visible from an aisle in the store from a location remote from said area.

20. The method of claim 17 further comprising:
determining the furniture accessories and other non-furniture products that are particularly likely to be marketable to the customers so attracted to the respective areas of the store; and
arranging the furniture accessories and other non-furniture products in the store for display by locating products among the different areas in accordance with the determination.

21. The method of claim 20 wherein:
the determining includes employing computerized marketing data correlation techniques to identify what furniture accessories and other non-furniture products are particularly likely to be marketable to the customers so attracted to the respective areas of the store.

22. The method of claim 20 wherein:
the determining includes selecting one or more persons skilled in an art selected from the group consisting of design, decorating, marketing, and merchandising, and having such person or persons make, based on their knowledge, experience or skill, the determination of what furniture accessories and other non-furniture products are particularly likely to be marketable to the customers so attracted to the respective areas of the store.

23. A retail furniture store comprising:
a store enclosure;
a display area within the store enclosure which includes a plurality of pods, each of the pods containing home furnishings and decorative accessories available for sale, the home furnishings and decorative accessories of the different pods being of respectively different styles, the home furnishings and decorative accessories of each respective pod including furniture and home furnishings and decorative accessories selected from the group consisting essentially of all coverings, floor coverings, window coverings, electronics, lighting fixtures, sculpture, mirrors and pictures that are mutually compatible in design;
a checkout location within the store enclosure;
an array of generally straight and intersecting aisles within the display area, the aisles providing pedestrian access to, from and among each of the pods and the checkout location, the array including aisles terminating in groupings of furniture, each of a different given style;
an entry space communicating and providing pedestrian passage between the outside of the enclosure and the array of aisles of the display area; and
the plurality of pods containing furniture groupings and accessories arranged as at least portions of each of a plurality of rooms of a house or other residence, each pod having contents that are visually and physically unified, and visually and physically separated from the contents of each of the other pods, by components selected from the group consisting essentially of aisles, lighting, floor finish, floor color, floor covering, floor elevation, signage and walls.

24. A retail furniture store comprising:
a plurality of pods, each pod corresponding to a furnished room decorated according to a respective lifestyle;
a plurality of aisles segmenting the plurality of pods into a plurality of sets of one or more related pods; and
a corresponding furniture display located adjacent each set of related pods, each corresponding furniture display selected to be mutually compatible in design with the corresponding set of related pods.

25. The store of claim 24 wherein:
each corresponding furniture display is located at an end of one of the aisles.

26. The store of claim 24, further comprising:
a checkout location.

27. The store of claim 24 wherein:
each corresponding furniture display is located at an end of one of the aisles.

28. A method of arranging furniture, comprising the steps of:
a) organizing a section of a store with furniture associated with a particular furniture style;
b) identifying other furniture and non-furniture accessories interesting to consumers attracted to the particular furniture style; and
c) decorating the section with one or more of the identified accessories.

29. The method of claim 28, further comprising the step of:
repeating steps a) -c) for a plurality of different furniture styles within a furniture store.
